(19) United States
(12) Patent Application Publication
(10) Pub. No.: US 2026/0300882 A1
(43) Pub. Date: Oct. 1, 2026

(54) SYSTEMS AND METHODS FOR READINESS SCORING

(71) Applicant: Russell Innovation Center for Entrepreneurs, Atlanta, GA (US)

(72) Inventors: James M. Bailey, Atlanta, GA (US); Malcolm Muhammad, PhD., Atlanta, GA (US); Monica Delores Hooks, Atlanta, GA (US)

(21) Appl. No.: 19/096,406

(22) Filed: Mar. 31, 2025

(51) Int. Cl. G06Q 10/0637

(52) U.S. Cl. CPC G06Q 10/0637

(57) ABSTRACT

Embodiments of the present disclosure relate to creating a readiness score report. From a readiness survey, a set of assessment data may be obtained. From the set of assessment data, a set of readiness scores may be determined. From the set of assessment data and the set of readiness scores, a readiness score report may be generated. The readiness score report may be distributed to a set of stakeholders.

### TECHNICAL FIELD

Aspects of the present disclosure relate to readiness scores, and more particularly, to managing Russell Innovation Center for Entrepreneurs (RICE) Big IDEAS stages.

### BACKGROUND

Assessing a business is a critical aspect of strategic planning and decision-making in both corporate management and investment contexts. Various traditional methods, such as financial ratios, discounted cash flow analysis, and market comparisons, have been employed for decades to assess business performance. However, most existing programs fail to measure or provide nuanced categorization and do not consider, beyond financial performance, other significant factors such as market expertise, branding, value chain, or legacy planning, or consider scaling independently of investor funding.

### BRIEF DESCRIPTION OF THE DRAWINGS

The described embodiments and the advantages thereof may be best understood by reference to the following description taken in conjunction with the accompanying drawings. These drawings in no way limit any changes in form and detail that may be made to the described embodiments without departing from the spirit and scope of the described embodiments.

FIG. 1 is a block diagram that illustrates an example readiness score management architecture, in accordance with some embodiments.

FIG. 2 is a block diagram of a readiness score management architecture, in accordance with some embodiments.

FIG. 3 is an example of a RICE Readiness Score report, in accordance with some embodiments.

FIG. 4 is an example of a RICE Readiness report, in accordance with some embodiments.

FIG. 5 is a flow diagram of a method of determining a readiness score, in accordance with some embodiments.

FIG. 6 is a component diagram depicting an example readiness score management architecture, in accordance with embodiments of the disclosure.

FIG. 7 is a block diagram of an example computing device that may perform one or more of the operations described herein, in accordance with some embodiments of the present disclosure.

### DETAILED DESCRIPTION

The business evaluation system presented in this disclosure provides a structured and systematic approach to assessing a business's performance across multiple dimensions. As an incubator, it is important to enhance decision-making for investors, stakeholders, and incubator managers by offering a detailed framework for assessing the startups they support. The system involves a collection of key indicators, including financial performance metrics, market position and competitive advantage, operational efficiency, innovation and growth potential, qualitative assessment, and data integration and reporting. In some embodiments, the indicators are summarized in five IDEAS stages: (1) Inspire; (2) Develop; (3) Execute; (4) Accelerate; and (5) Scale.

Incubators provide startups with access to resources, mentorship, funding, and networking opportunities that can be essential for their development. However, the performance of the startups they support can vary significantly depending on factors such as operational efficiency, industry focus, mentorship quality, and financial health. Each indicator is designed to provide a holistic evaluation of the business, with the flexibility to adapt to various industries, organizational sizes, and operational models. The result is an evaluation model that not only assesses current performance but also predicts future potential, enabling stakeholders to make informed decisions based on a comprehensive understanding of the business's health. By integrating financial, operational, and qualitative evaluation components, the disclosure provides a holistic and actionable approach to understanding startup viability and identifying the most appropriate resources and support.

The foundation of any business evaluation is its financial performance. This component involves a thorough analysis of the company's financial statements, including income statements, balance sheets, and cash flow statements. Key financial ratios such as Return on Investment (ROI), Return on Equity (ROE), Gross Profit Margin, Operating Margin, and Debt-to-Equity Ratio can be calculated and analyzed to provide insights into the company's profitability, financial stability, and operational efficiency.

A business's position in the marketplace can also be a critical factor in determining its long-term viability and growth potential. This component involves an analysis of the company's market share, customer base, and positioning relative to its competitors. Key considerations include market penetration, brand strength, customer loyalty, and barriers to entry. A business with a strong competitive advantage in these areas is likely to maintain or increase its profitability over time.

Operational efficiency is a key driver of business performance. This component evaluates the effectiveness of a company's internal operations, focusing on its ability to produce goods or services efficiently, minimize costs, and optimize resource allocation. Key metrics for operational efficiency include inventory turnover, employee productivity, cost of goods sold (COGS), and supply chain management. The system may also assess the business's adoption of technology and automation in streamlining processes and improving efficiency. Businesses with high operational efficiency can achieve a lower cost base and higher margins, contributing to a more sustainable competitive position.

To evaluate a business's future prospects, it is important to consider its ability to innovate and sustain growth. This component examines the company's investments in research and development (R&D), its product development pipeline, and its adaptability to changing market conditions. The system uses innovation metrics such as the number of new products launched, patents filed, and the company's ability to respond to market disruptions. Additionally, the growth potential is assessed by evaluating market trends, consumer preferences, and emerging technologies that could impact the industry. Companies with a robust innovation strategy and strong growth prospects are more likely to maintain long-term profitability.

While quantitative metrics provide essential data points, qualitative factors are equally important in evaluating a business. This component involves an in-depth analysis of the company's leadership, organizational culture, reputation, and customer satisfaction. Interviews with key stakeholders, surveys of employees and customers, and third-party reputation assessments provide valuable insights into the intangible aspects of business performance. Strong leadership, a positive corporate culture, and high levels of customer satisfaction can be strong indicators of a company's future success.

The final component of the business evaluation system involves the integration of all collected data into a unified reporting structure. The system uses advanced data analytics tools to process the various financial and non-financial metrics, creating a comprehensive and visual report that allows stakeholders to easily interpret the results. The report may also include predictive modeling to forecast future performance based on historical trends. This data integration ensures that decision-makers have a complete picture of the business's performance, enabling informed and strategic decisions.

An internal algorithm aims to provide a nuanced diagnostic tool for entrepreneurs, emphasizing business scalability and the need for tailored support rather than a one-size-fits-all approach. Existing programs tend to broadly categorize entrepreneurs, rather than providing a more detailed assessment that considers individual needs. Such an approach is intended to help entrepreneurs effectively navigate their unique stages of growth.

Challenges faced by entrepreneurs in accessing venture capital can also be addressed, with a shift in focus towards sustainable business growth, and refining customer segmentation to better serve diverse needs within the entrepreneurial community. The Big IDEAS curriculum categorizes entrepreneurs into five stages based on their annual recurring revenue, commencing with an initial Inspire stage. The program's data-driven assessments aim to provide detailed insights into entrepreneurs, facilitating scalable coaching and targeted support.

The RICE Readiness Score's scoring system includes deliverables linked to each stage. Scores are normalized as part of the cumulative nature of the assessment, in which one stage can incorporate questions associated with an earlier stage so as to provide a comprehensive evaluation. Scores are adjusted based on the number of questions associated with each indicator to maintain a consistent one to ten scale. The RICE Readiness Score algorithm forecasts business growth and scalability, and provides a diagnostic tool that differentiates between entrepreneurs at various stages, allowing for tailored mentoring and support during incubation. Most existing programs fail to effectively measure or provide nuanced categorization. In some embodiments, candidate feedback can be incorporated into their internal review, helping determine appropriate stage placements based on readiness scores. An initial sorting of candidates can allow quick adjustments during the review process.

In some embodiments, for the Inspire stage, deliverables for a Communication indicator include a pitch deck and a vision statement. In some embodiments, for the Inspire stage, deliverables for a Market Expertise indicator include market/industry research. In some embodiments, for the Inspire stage, deliverables for a Strategic Insight indicator include a problem statement, a business model canvas, and a product/service innovation plan. In some embodiments, for the Inspire stage, deliverables for a Financial Position indicator include a budget.

In some embodiments, for the Develop stage, deliverables for an Evidence indicator include customer discovery feedback and prototype/MVP development. In some embodiments, for the Develop stage, deliverables for a Branding indicator include a brand kit and market penetration/go-to-market strategy. In some embodiments, for the Develop stage, deliverables for a Capital Readiness indicator include a pricing and unit economics strategy. In some embodiments, for the Develop stage, deliverables for a Compliance indicator include legal and accounting compliance.

In some embodiments, for the Execute stage, deliverables for a Customer Acquisition indicator include a customer acquisition plan and a marketing and communications plan. In some embodiments, for the Execute stage, deliverables for a Value Chain indicator include a supply chain and operations plan. In some embodiments, for the Execute stage, deliverables for a Strategic Plan indicator include a strategic plan. In some embodiments, for the Execute stage, deliverables for a Financial Performance indicator include revenue models and financial projections. In some embodiments, for the Execute stage, deliverables for an Operating Systems indicator include a human resources (HR) plan.

In some embodiments, for the Accelerate stage, deliverables for a Strategic Partnerships indicator include a partnership strategy. In some embodiments, for the Accelerate stage, deliverables for an Expansion indicator include a growth/expansion strategy. In some embodiments, for the Accelerate stage, deliverables for an Investing indicator include an investment and resource allocation strategy and financial reporting. In some embodiments, for the Accelerate stage, deliverables for a Management Structure indicator include an advisory and governance plan. In some embodiments, for the Accelerate stage, deliverables for a Legacy Planning indicator include a legacy/exit planning strategy.

Many entrepreneurs face challenges in accessing venture capital and need support in building sustainable businesses that can scale independently of investor funding. For many, traditional venture capital strategies may not be the best fit. The Big IDEAS curriculum segments entrepreneurs into five stages based on their revenue and development status. The data collected through assessments allows for a granular understanding of entrepreneurs at each stage, providing a unique advantage for the program. The RICE Readiness Score helps determine a business's stage placement and identifies areas for improvement. In some embodiments, a stage score below 70 can indicate a need for focus, often in execution, and the RICE Readiness framework can condense lengthy coaching discussions into targeted action plans.

The assessment can also help to decouple a business's health from a founder's identity. Often, clients take excessive pride in their current stage, which can lead to misunderstandings about the growth process and hinder advancement. Indicator scores can provide a less emotional basis for discussion.

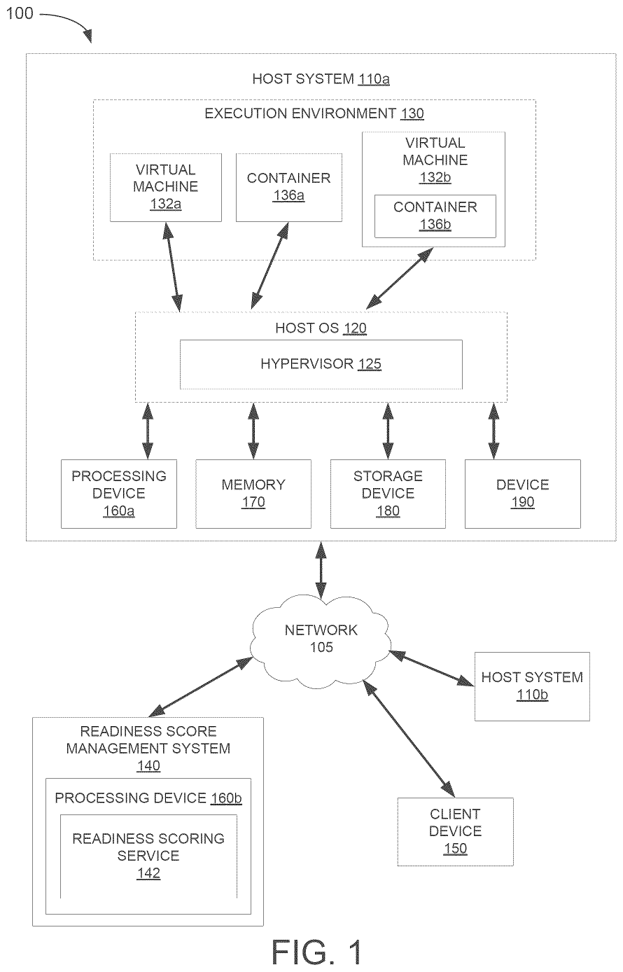

FIG. 1 is a block diagram 100 that illustrates an example readiness score management architecture 100, in accordance with some embodiments. However, other readiness score management architectures are possible, and the implementation of a computer system utilizing examples of the disclosure are not limited to the specific architecture depicted by FIG. 1.

As shown in FIG. 1, readiness score management architecture 100 includes host systems 110a and 110b, readiness score management system 140, and client device 150. The host systems 110a and 110b, readiness score management system 140, and client device 150 may each include hardware such as processing devices 160a and 160b, memory 170, which may include volatile memory devices, e.g., random access memory (RAM), non-volatile memory devices, e.g., flash memory, and/or other types of memory devices, a storage device 180, e.g., one or more magnetic hard disk drives, a Peripheral Component Interconnect (PCI) solid state drive, a Redundant Array of Independent Disks (RAID) system, or a network attached storage (NAS) array, and one or more devices 190, e.g., a Peripheral Component Interconnect (PCI) device, a network interface controller (NIC), a video card, or an I/O device. In certain implementations, memory 170 may be non-uniform access (NUMA), such that memory access time depends on the memory location relative to processing devices 160a and 160b. It should be noted that although, for simplicity, a single processing device 160a or 160b, storage device 180, and device 190 are depicted in FIG. 1, other embodiments of host systems 110a and 110b, readiness score management system 140, and client device 150 may include multiple processing devices, storage devices, or devices. Processing devices 160a and 160b may include a complex instruction set computing (CISC) microprocessor, a reduced instruction set computing (RISC) microprocessor, a very long instruction word (VLIW) microprocessor, or a processor implementing other instruction sets or processors implementing a combination of instruction sets. Processing devices 160a and 160b may also include one or more special-purpose processing devices such as an application specific integrated circuit (ASIC), a field programmable gate array (FPGA), a digital signal processor (DSP), a network processor, or the like.

Each of the host systems 110a and 110b, readiness score management system 140, and client device 150 may be a server, a mainframe, a workstation, a personal computer (PC), a mobile phone, a palm-sized computing device, etc. In some embodiments, host systems 110a and 110b, readiness score management system 140, and/or client device 150 may be separate computing devices. In some embodiments, host systems 110a and 110b, readiness score management system 140, and/or client device 150 may be implemented by a single computing device. For clarity, some components of readiness score management system 140, host system 110b, and client device 150 are not shown. In some embodiments, readiness score management system 140 may include a virtual machine-orchestration system. Furthermore, although on-the-fly confidential virtual machine architecture 100 is illustrated as having two host systems, embodiments of the disclosure may utilize any number of host systems.

Host systems 110a and 110b, and readiness score management system 140, may also include an execution environment 130, which may include one or more virtual machines (VMs) 132a, containers 136a, containers 136b residing within virtual machines 132b, and a host operating system (OS) 120. Execution environment 130 may also include one or more unikernels 138. VMs 132a and 132b are software implementations of machines that execute programs as though they were actual physical machines. Containers 136a and 136b act as isolated execution environments for different workloads of services, as previously described. Host OS 120 manages the hardware resources of the host system 110a and provides functions such as inter-process communication, scheduling, memory management, and so forth.

Host OS 120 may include a hypervisor 125, also known as a virtual machine monitor (VMM), which can provide a virtual operating platform for VMs 132a and 132b, container 136a, and unikernel 138, and manage their execution. Hypervisor 125 may manage system resources, including access to physical processing devices, e.g., processors or CPUs, physical memory, e.g., RAM, storage devices, e.g., HDDs or SSDs, and other devices, e.g., sound cards or video cards. The hypervisor 125, typically implemented in software, may emulate and export a bare machine interface to higher level software in the form of virtual processors and guest memory. Higher level software may comprise a standard or real-time OS, may be a highly stripped-down operating environment with limited operating system functionality, and may include traditional OS facilities, etc. Hypervisor 125 may present other software, i.e., “guest” software, the abstraction of one or more VMs that provide the same or different abstractions to various guest software, e.g., a guest operating system or guest applications. It should be noted that in some alternative implementations, hypervisor 125 may be external to host OS 120, rather than embedded within host OS 120, or may replace host OS 120.

The host systems 110a and 110b, readiness score management system 140, and client device 150 are coupled to each other, e.g., may be operatively coupled, communicatively coupled, or may communicate data/messages with each other, via network 105. Network 105 may be a public network, e.g., the internet, a private network, e.g., a local area network (LAN) or a wide area network (WAN), or a combination thereof. In one embodiment, network 105 may include a wired or a wireless infrastructure, which may be provided by one or more wireless communications systems, such as a WiFi™ hotspot connected with the network 105 and/or a wireless carrier system that can be implemented using various data processing equipment and communication towers, e.g., cell towers. The network 105 may carry communications, e.g., data, messages, packets, or frames, between the various components of host systems 110a and 110b, readiness score management system 140, and/or client device 150.

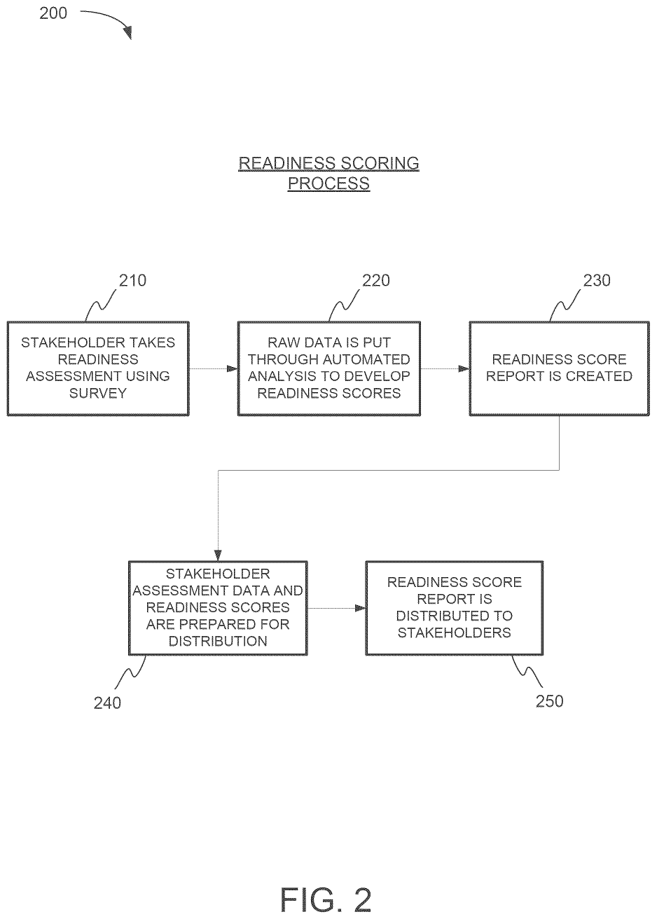

In some embodiments, processing device 160b may execute readiness scoring service 142. In some embodiments, client device 150 may send a request for a readiness score report to readiness score management system 140. In some embodiments, readiness score management system 140 may respond with the readiness score report. Further details regarding readiness scoring service 142 will be discussed at FIGS. 2-7 below.

FIG. 2 is a block diagram 200 of a readiness score management architecture, in accordance with some embodiments. At 210, a stakeholder takes a readiness assessment using a survey. In some embodiments, this readiness assessment involves answering a series of questions. In some embodiments, the series of questions span a set of readiness indicators. In some embodiments, the readiness indicators are categorized into a set of Big IDEAS stages, e.g., four stages, which will produce an average readiness score according to the expected outcomes of each stage (Inspire, Develop, Execute, and Accelerate). In some embodiments, each statement will prompt for an option that best represents an experience or capability. In some embodiments, some questions prompt for an “Absolutely,” “Yes,” “Somewhat,” “No,” or other exclusive answer. In some embodiments, some questions prompt for a numeric response.

In some embodiments, some questions will solicit business growth information, including business growth details, e.g., total employees, accurate annual revenue, and fundraising numbers from the past year. In some embodiments, prompts will solicit business readiness and growth documentation, e.g., evidence supporting business growth and readiness, and will accept documents or data to substantiate responses, e.g., profit and loss statements, cash flow statements, and income statements.

In some embodiments, after submitting responses, no changes can be made.

Referring to FIG. 2, at 220, raw data is put through an automated analysis to develop a set of readiness scores. In some embodiments the answers to these questions are assigned scores. In some embodiments, a “Yes” or “Absolutely” answer receives a maximum score, a “No” or “Never” answer receives a minimum score, and other answers receive scores between a maximum and minimum score. In some embodiments, scores associated with an answers to particular questions are accumulated for a particular stage. In some embodiments, a score associated with an answer to a particular question may be applied to multiple stages. In some embodiments, the scores may be normalized such that a particular indicator within a particular stage is given a value between one and ten.

At 230, a readiness score report is created.

At 240, the stakeholder assessment data and readiness scores are prepared for distribution.

At 250, the readiness score report is distributed to stakeholders.

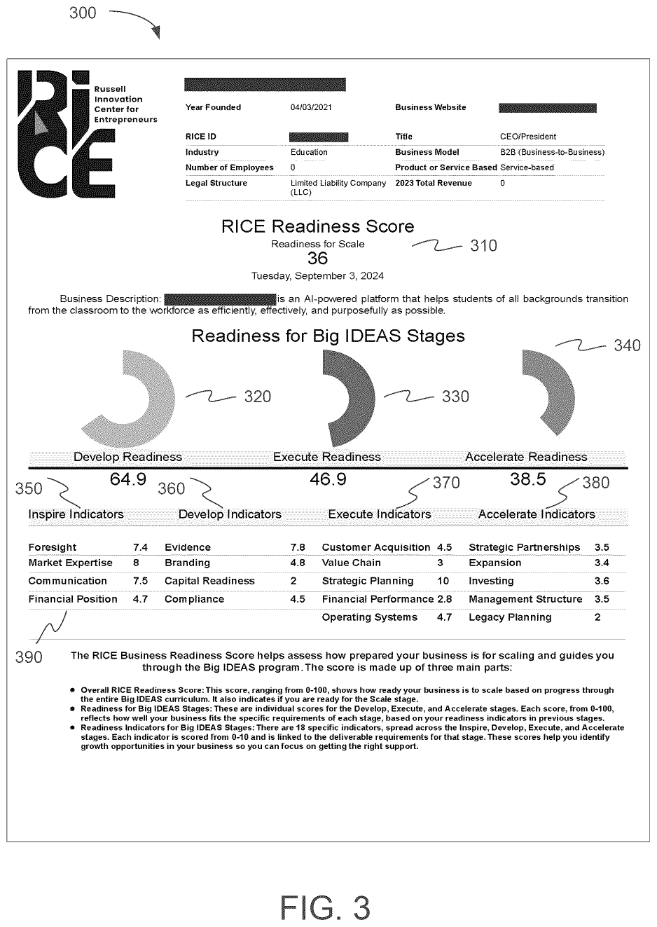

FIG. 3 is an example of a RICE Readiness Score report 300, according to some embodiments. The report 300 shows a set of indicator headings, e.g., Inspire Indicators 350, Develop Indicators 360, Execute Indicators 370, and Accelerate Indicators 380, and each of the headings has a columnar list of indicators with individual scores 390. In some embodiments, the scores fall between one and ten.

The report 300 also shows a set of Readiness for Big IDEAS Stage scores. In an embodiment, Develop Readiness 320 is assigned a score, as are Execute Readiness 330 and Accelerate Readiness 340. In some embodiments these scores differ from the simple summation of the Develop Indicators 360, Execute Indicators 370, and Accelerate Indicators 380. In some embodiments these scores are normalized to lie between zero and one hundred.

The report 300 further indicates a RICE Readiness Score 310, which is an overall assessment of the subject business's readiness to scale. In some embodiments, the RICE Readiness Score 310 is normalized to lie between zero and one hundred.

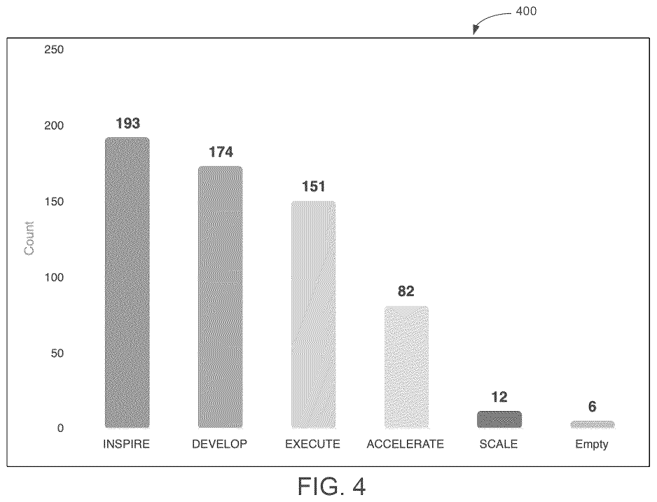

FIG. 4 is an example of a RICE Readiness report 400, according to some embodiments. In an embodiment, RICE Readiness report 400 shows a histogram of the number of startups in the Inspire, Develop, Execute, Accelerate, and Scale categories. In some embodiments, the report 400 shows an entry for those startups that have not submitted a readiness assessment.

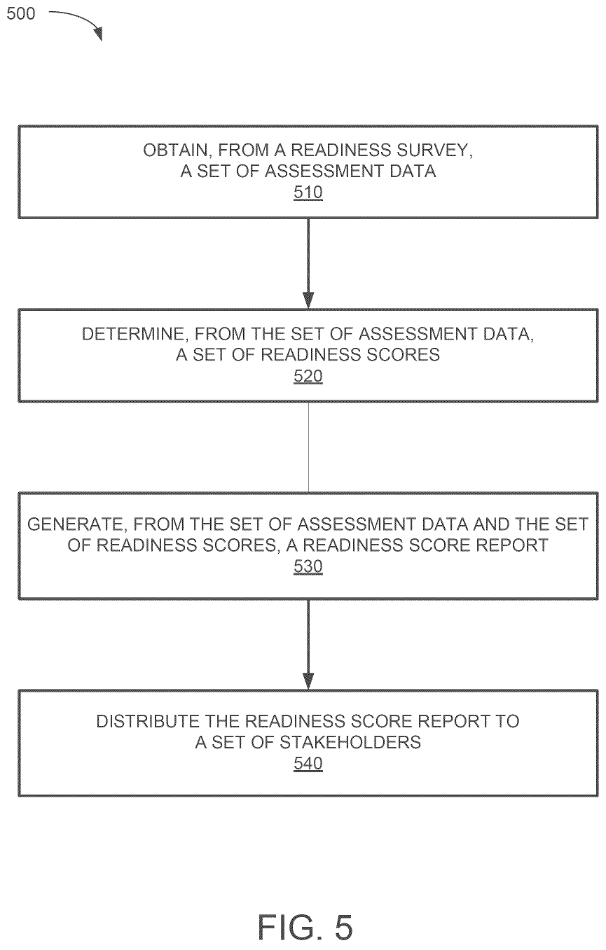

FIG. 5 is a flow diagram of a method 500 of managing or controlling a readiness score, in accordance with some embodiments. Method 500 may be performed by processing logic that may comprise hardware, e.g., circuitry, dedicated logic, programmable logic, a processor, a processing device, a central processing unit (CPU), a system-on-a-chip (SoC), software, e.g., instructions running/executing on a processing device, firmware, e.g., microcode, or a combination thereof. In some embodiments, at least a portion of method 500 may be performed by readiness score management system 140 of FIG. 1.

With reference to FIG. 5, method 500 illustrates example functions used by various embodiments. Although specific function blocks (“blocks”) are disclosed in method 500, such blocks are examples. That is, some embodiments are well suited to performing various other blocks or variations of the blocks recited in method 300. It is appreciated that the blocks in method 500 may be performed in an order different than presented, and that not all of the blocks in method 500 may be performed.

Method 500 begins at block 510, where the processing logic obtains, from a readiness survey, a set of assessment data. The readiness survey focuses on business scalability and lends itself to tailored support rather than a one-size-fits-all approach, advocating for a more detailed assessment that considers individual needs. This approach is designed to help entrepreneurs navigate their unique stages of growth effectively. By contrast, existing programs tend to broadly categorize entrepreneurs. Refining customer segmentation can better serve diverse needs within the entrepreneurial community. In some embodiments, the Big IDEAS curriculum categorizes entrepreneurs into five stages based on their annual recurring revenue. The program's data-driven assessments aim to provide detailed insights into entrepreneurs, facilitating scalable coaching and targeted support.

At block 520, the processing logic determines, from the set of assessment data, a set of readiness scores. In some embodiments, these scores are adjusted based on the number of questions associated with a particular indicator so as to maintain a consistent one to ten scale. In some embodiments, the scoring system is cumulative, where later stages incorporate elements from previous stages.

At block 530, the processing logic generates, from the set of assessment data and the set of readiness scores, a readiness score report. In some embodiments, the generation involves a formatter that specifies the scores for individual indicators, for Big IDEAS stages, and an overall readiness score. In some embodiments, the stages include inspiring, developing, executing, and accelerating.

At block 540, the processing logic distributes the readiness score report to stakeholders.

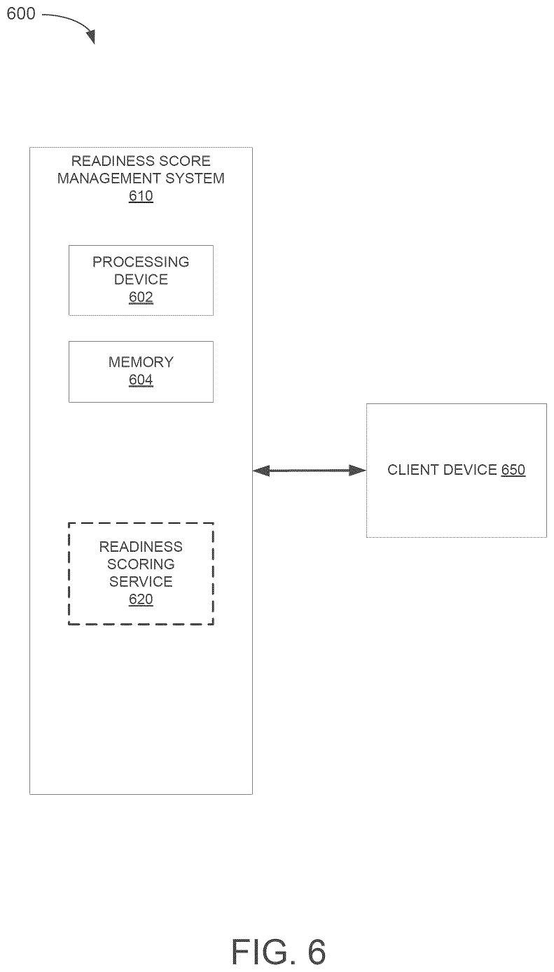

FIG. 6 is a component diagram depicting an example readiness score management architecture 600, in accordance with embodiments of the disclosure. The readiness score management architecture 600 includes readiness score management system 610, processing device 602, memory 604, readiness scoring service 620, and client device 650. Readiness score management system 610 may correspond to host system 110a of FIG. 1. Readiness score management system 610 may include an execution environment that may correspond to execution environment 130 of FIG. 1. An execution environment included in readiness score management system 610 may include VMs, containers, one or more containers within a VM, or one or more unikernels. Readiness score management system 610 may include any number of execution environments. Readiness score management system 610 may correspond to readiness score management system 140 of FIG. 1. Readiness scoring service 620 may correspond to readiness scoring service 142 of FIG. 1. In some embodiments, processing device 602 may correspond to processing device 160a of FIG. 1. In some embodiments, memory 604 may include volatile memory devices, e.g., random access memory (RAM), non-volatile memory devices, e.g., flash memory, and/or other types of memory devices.

Readiness score management system 610 may receive a request to generate or distribute a readiness report, causing processing device 402 and memory 404 to submit instructions to readiness scoring service 620. In some embodiments, readiness score management system 610 corresponds to readiness score management system 140 of FIG. 1. In some embodiments, readiness scoring service 620 corresponds to readiness scoring service 142 of FIG. 1. In some embodiments, readiness score management system 610 prompts for answers to a series of questions associated with indicators for Big IDEAS stages. It should be noted that readiness scoring service 520 is shown for illustrative purposes only and is not a physical component of readiness score management system 510.

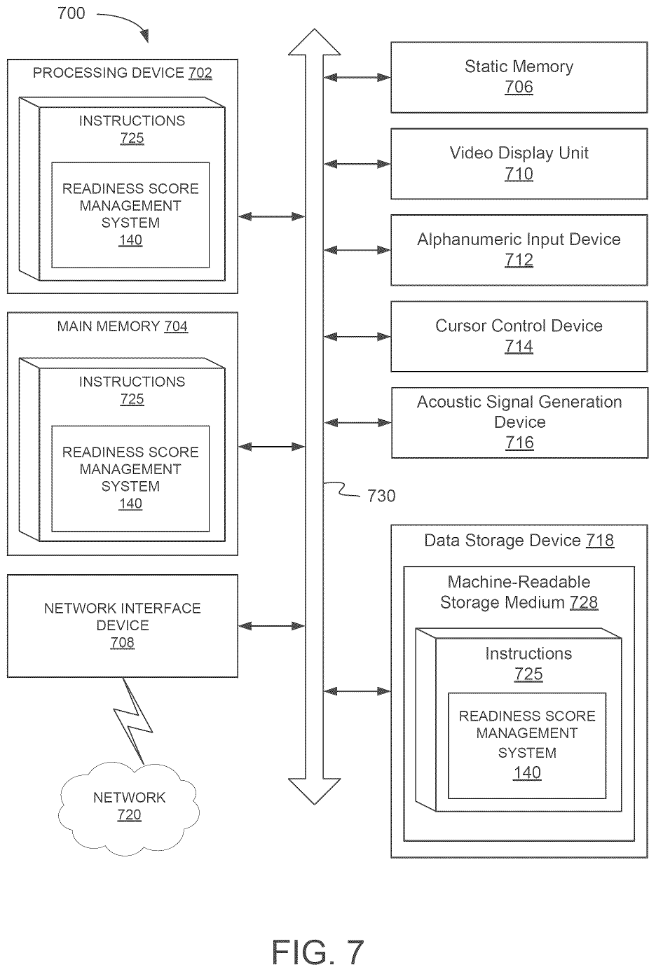

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, a switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device 702, e.g., a general-purpose processor or a programmable logic device (PLD), a main memory 704, e.g., a synchronous dynamic random-access memory (DRAM) or a read-only memory (ROM), a static memory 706, e.g., flash memory, and a data storage device 718, which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), a network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710, e.g., a liquid crystal display (LCD) or a cathode ray tube (CRT), an alphanumeric input device 712, e.g., a keyboard, a cursor control device 714, e.g., a mouse, and an acoustic signal generation device 716, e.g., a speaker. In one embodiment, video display unit 710, alphanumeric input device 712, and cursor control device 714 may be combined into a single component or device, e.g., an LCD touch screen.

Data storage device 718 may include a computer-readable storage medium 728 on which may be stored one or more sets of instructions 725 that may include instructions for a readiness score management system 140, further including a readiness scoring service (not shown) for carrying out the operations described herein, in accordance with one or more aspects of the present disclosure. Instructions 725 may also reside, completely or at least partially, within main memory 704 and/or within processing device 702 during execution thereof by computing device 700, main memory 704 and processing device 702 also constituting computer-readable media. The instructions 725 may further be transmitted or received over a network 720 via network interface device 708.

While computer-readable storage medium 728 is shown in an illustrative example to be a single medium, the term “computer-readable storage medium” should be taken to include a single medium or multiple media, e.g., a centralized or distributed database and/or associated caches and servers, which stores the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “obtaining,” “creating,” “transferring,” “probing,” “deleting,” or “authenticating,” or the like, refer to actions and processes performed or implemented by computing devices that manipulate and transform data represented as physical (electronic) quantities within the computing device's registers and memories into other data similarly represented as physical quantities within the computing device memories or registers, or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” connotes structure by indicating that the units/circuits/components include structure, e.g., circuitry, which performs the task or tasks during operation. As such, the unit/circuit/component can be said to be configured to perform the task, or is configurable to perform the task, even when the specified unit/circuit/component is not currently operational, e.g., is not on. The units/circuits/components used with the “configured to” or “configurable to” language include hardware, e.g., circuits and memory storing program instructions executable to implement the operation. Reciting that a unit/circuit/component is “configured to” perform one or more tasks, or is “configurable to” perform one or more tasks, is expressly intended to not invoke 35 U.S.C. § 112(f) for that unit/circuit/component. Additionally, “configured to” or “configurable to” can include generic structure, e.g., generic circuitry, which is manipulated by software and/or firmware, e.g., an FPGA or a general-purpose processor executing software, to operate in manner that is capable of performing the task(s) at issue. “Configured to” may also include adapting a manufacturing process, e.g., a semiconductor fabrication facility, to fabricate devices, e.g., integrated circuits, which are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the disclosure is not to be limited to the details given herein, but may be modified within the scope and equivalents of the appended claims.

What is claimed is:

1. A method comprising:
obtaining, by a processing device, from a readiness survey, a set of assessment data;
determining, from the assessment data, a set of readiness scores;
generating, from the set of assessment data and the set of readiness scores, a readiness score report; and
distributing the readiness score report to a set of stakeholders.

2. The method of claim 1, wherein the readiness score report is formatted for readability.

3. The method of claim 1, wherein the readiness scores are combined as stage values.

4. The method of claim 3, wherein each readiness score of the set of readiness scores contributes to a plurality of stage values.

5. The method of claim 1, wherein the assessment data comprises at least one of discrete values and qualitative data.

6. The method of claim 1, wherein the assessment data is categorized based on annual recurring revenue.

7. The method of claim 1, wherein the readiness report identifies a business's stage placement and areas for improvement.

8. A system comprising:
a memory; and
a processing device, operatively coupled to the memory, to:
obtain, from a readiness survey, a set of assessment data;
determine, from the assessment data, a set of readiness scores;
generate, from the set of assessment data and the set of readiness scores, a readiness score report;
distribute the readiness score report to a set of stakeholders.

9. The system of claim 8, wherein the processing device formats the readiness score report for readability.

10. The system of claim 8, wherein the processing device combines the readiness scores as stage values.

11. The system of claim 10, wherein each readiness score of the set of readiness scores contributes to a plurality of stage values.

12. The system of claim 8, wherein the assessment data comprises at least one of discrete values and qualitative data.

13. The system of claim 8, wherein the processing device is further to categorize assessment data based on annual recurring revenue.

14. The system of claim 8, wherein the processing device is further to identify a business's stage placement and areas for improvement.

15. A non-transitory computer-readable storage medium including instructions that, when executed by a processing device, cause the processing device to:
obtain, from a readiness survey, a set of assessment data;
determine, from the assessment data, a set of readiness scores;
generate, from the set of assessment data and the set of readiness scores, a readiness score report;
distribute the readiness score report to a set of stakeholders.

16. The non-transitory computer-readable storage medium of claim 15, wherein the readiness score report is formatted for readability.

17. The non-transitory computer-readable storage medium of claim 15, wherein the instructions further cause the processing device to format the readiness score report for readability.

18. The non-transitory computer-readable storage medium of claim 15, instructions further cause the processing device to combine the readiness scores as stage values.

19. The non-transitory computer-readable storage medium of claim 18, wherein each readiness score of the set of readiness scores contributes to a plurality of stage values.

20. The non-transitory computer-readable storage medium of claim 15, wherein the instructions further cause the processing device to identify a business's stage placement and areas for improvement.
